(19) United States
(12) Patent Application Publication
(10) Pub. No.: US 2007/0070880 A1
(43) Pub. Date: Mar. 29, 2007

(54) METHOD AND APPARATUS FOR NOTIFICATION OF A SUBGROUP WITHIN A MULTIPLEXED MESSAGE

(75) Inventors: Zhijun Cai, Euless, TX (US); Mansoor Ahmed, Hurst, TX (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/531,775

(22) Filed: Sep. 14, 2006

Related U.S. Application Data
(60) Provisional application No. 60/721,734, filed on Sep. 29, 2005.

(51) Int. Cl. H04J 11/00; H04J 3/24

(52) U.S. Cl. 370/208; 370/349

(57) ABSTRACT

A method and apparatus for notifying a communication device (108, 110) of an allocation of data within a multiplexed message (200) is provided. The method includes grouping the data of an at least one wireless communication device (108, 110) into the multiplexed message, dividing the multiplexed message into at least one subgroup (202-210) wherein each subgroup has at least one tone (212-224) and is within the message, assigning the wireless device one of the at lest one subgroups, and notifying the wireless communication device of the assigned subgroup with an identification sequence (302) used to identify the wireless communication device within the multiplexed message, a first index (306) to identify when the assigned subgroup includes new data for the wireless communication device and a second index (304) to identify which subgroup within the multiplexed message contains data for the wireless communication device.

### FIELD OF THE INVENTION

The present invention relates generally to notification messages and, in particular to messages that inform users of assigned subgroups within multiplexed messages.

### BACKGROUND

Orthogonal Frequency Division Multiplexing (OFDM) is a multi-carrier technique that distributes data over a large number of carriers that are spaced apart at precise frequencies. This spacing prevents the demodulators from seeing frequencies other their own. OFDM transmits large amounts of digital data over a radio wave by splitting the data stream into multiple smaller sub-data streams. The sub data streams are then transmitted at different frequencies or sets of frequency to a receiver. OFDM can reduce the amount of crosstalk in signal transmissions and provides other benefits over other modes of wireless communication methods including time division multiple access and code division multiple access techniques.

OFDM is a technique that divides the spectrum into a number of equally spaced orthogonal tones and carries a portion of a user's information on each tone or a set of tone. OFDM allows the spectrum of each tone to overlap, and because they are orthogonal, they do not interfere with each other. OFDM is a modulation technique in that it enables user data to be modulated onto tones or sets of tones. The information is modulated on a tone or a set of tones by adjusting the tone's phase or amplitude (M-ary Phase Shift Keying/M-ary Quadrature Amplitude Modulation).

For example, if a 100-tone system is used, a signal data stream with a rate of 1 megabit per second would be converted into 100 streams of 10 kilobits per second. Proper selection of system parameter, such as the number of tones and tone spacing, can greatly reduce, or even eliminate, inter signal interference because typical multi-path delay spread represents a much smaller proportion of the lengthened symbol time. Orthogonal Frequency Division Multiple Access (OFDMA) is a multiple-access technique wherein an individual tone or groups of tones can be assigned to different users. Multiple users share a given bandwidth in this manner. Each user can be assigned a predetermined number of tones based on the amount of information that they have to send. The assignments may be controlled by the high layer, which schedules the resource assignments based on user demand or other parameters.

Wireless voice communication networks such as Enhanced Universal Mobile Telecommunication System (EUMTS) can use OFDM technology. In such cases, voice channels are allocated a set number of tones within the multiplexed message in any number of methods. In order for the user to receive the signal, the user must know which set of tones within the multiplexed signal is assigned to that user so that it can demodulate the correct portion of the message and put it together with other data received.

There are a variety of ways to inform the user of the correct set of tones that are allocated to that user, but these methods can be cumbersome, take up a lot of overhead and delay scheduling. It is therefore needed to have a method and apparatus that notifies a user of the allocated tones within an OFDM data stream that reduces the notification overhead and achieves scheduling gain.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a wireless communication network used in accordance with the present invention.

FIG. 2 is an example OFDM message made in accordance with some embodiments of the invention.

FIG. 3 is a notification message made in accordance with at least one embodiment of the present invention.

FIG. 4 is another notification message made in accordance with at least one embodiment of the present invention.

FIG. 5 is a flow chart illustrating a method of notifying a device of the subgroup that contains data for the wireless communication device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and messages related to notifying a user of the subgroup of tones within an OFDM data stream that is allocated to that user. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a message to notify a user of the allocated subgroup of tones within an OFDM message is assigned to the user as described herein. The non-processor circuits may include, but are not limited to, a radio receiver, a radio transmitter, signal drivers, clock circuits, power source circuits, and user input devices. As such, these functions may be interpreted as steps of a method to perform notify a user of the subgroup of tones within an OFDM message that is allocated to the user. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention is directed to a method of notifying a wireless communication device of an allocation of data within a multiplexed message. In at least one embodiment of the present invention, the method includes the step of grouping the data for at least one wireless communication device into the multiplexed message. The multiplexed message is divided into at least one subgroup wherein each subgroup has at least one tone within the message. The user, which can be a wireless device, is assigned at least one subgroup. The user is notified of the assigned subgroup by an identification sequence used to identify the wireless communication device within the multiplexed message, a first index to identify when the assigned subgroup includes new data for the wireless communication device and a second index to identify which subgroup within the multiplexed message contains data for the wireless communication device. In another embodiment of the present invention, the method of notifying user of an allocation of data within a multiplexed message begins with the step of grouping the data for at least one user into the multiplexed message. The multiplexed message is then divided up into at least one subgroup wherein each subgroup has at least one tone for the user. The user is assigned one of the at least one subgroups. The user is notified of the assigned subgroup with an identification sequence used to identify the wireless communication device within the multiplexed message and an index to identify when the assigned subgroup includes new data for the wireless communication device and wherein the identification sequence and the index are sequenced in order within the message according to the number of the assigned subgroup.

In view of the foregoing, the present invention includes a message to notify a wireless communication device within an EUMTS of a subgroup within a multiplexed message having data for the wireless communication device. The message comprising an identification sequence used to identify the wireless communication device, a first index used to identify whether the multiplexed message contains data for the wireless communication device, and an indication of the subgroup within the multiplexed message.

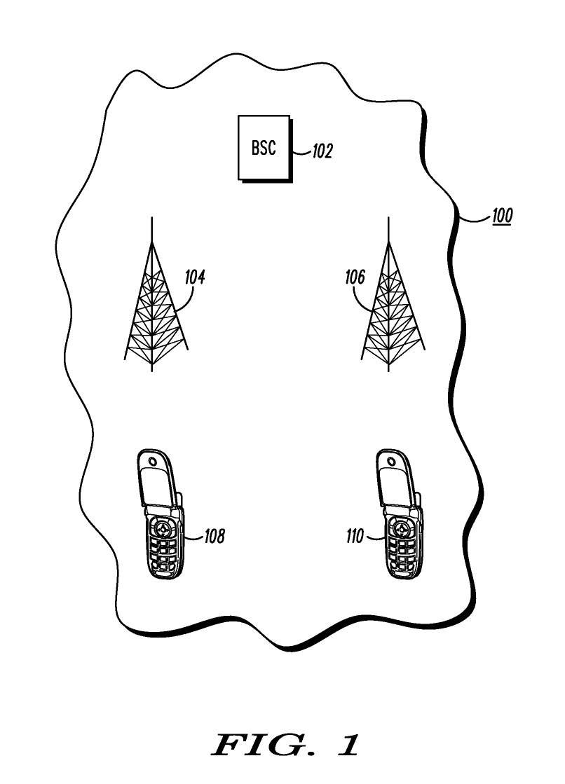

FIG. 1 illustrates a communication network 100 in which the present invention operates. Network 100 can be any sort of communication system and in at least one embodiment is a wireless communication system that can operate in one of several protocols including time division multiple access (TDMA), code division multiple access (CDMA), universal mobile telecommunication system (UMTS) or other known cellular technologies and wireless local area network technologies. In addition, network 100 can operate using orthogonal frequency division multiplexing.

Network 100 includes a base station controller (BSC) 102 and base transceiver sites (BTS) 104, 106. Communication devices 108, 110 operate within the system. Communication devices 108, 110 can be wireless communication devices such as cellular phones, dual-mode phones, personal digital assistants (PDAs), laptop computers and other such devices and elements needed to effectuate communications such as transceivers, controllers and a memory (not shown), all of which are known in the art. Using well established protocols and methods including OFDM technology, the BSC 102, BTSs 104, 106 and other known components within system 100 provide the infrastructure for communication devices 108, 110 to communicate with one another or with other communication devices outside system 100. It is possible that the base station controller and the base transceiver site are merged into a single entity.

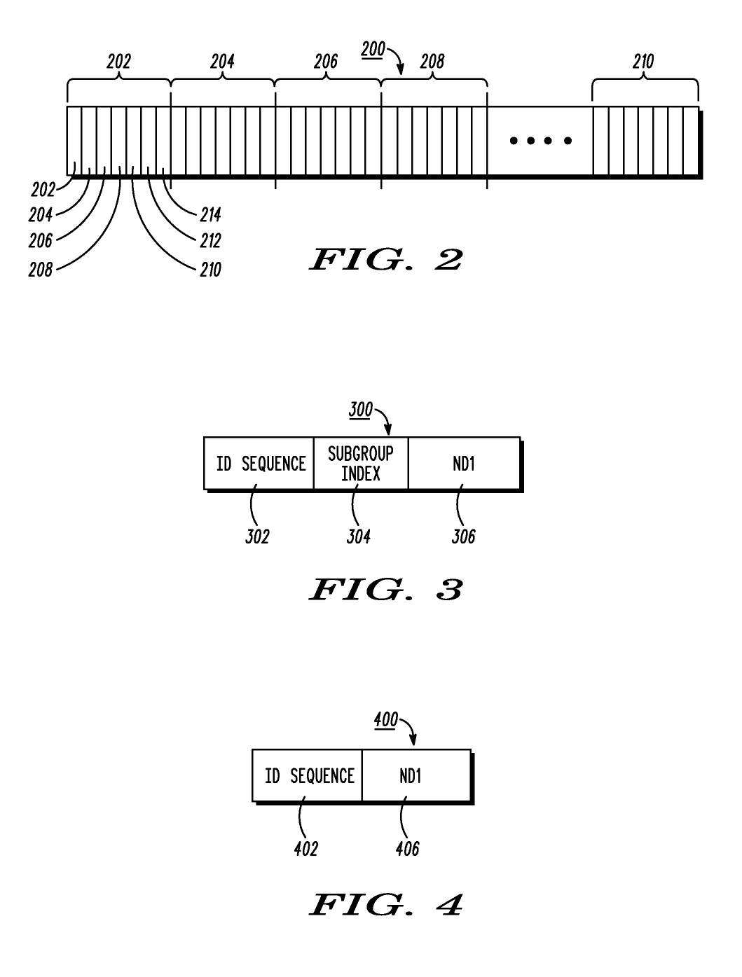

Turning to FIG. 2, a message 200 is shown. In at least one embodiment of the present invention, message 200 is an OFDM message or data stream that is sent between the BTSs 104, 106 and the devices 108, 110 according to OFDM standards. Message 200 can be sent between the BTSs 104, 106 toward the devices 108, 110 on the forward link and between the devices 108, 110 toward the BTSs 104, 106 on the reverse link.

The message 200 is divided up into subgroups 202, 204, 206, 208, 210. As seen, five subgroups 202-210 are shown, but it is understood by those of skill in the art that the number of subgroups can vary from one to a number L. The number of subgroups may depend on numerous factors, as described below. Each subgroup is then allocated a number of tones 212, 214, 216, 218, 220, 222, 224. Allocation of tones will be described more fully below. As seen, each subgroup 202-210 includes seven tones 212-224, but it is understood by those of skill in the art that the number of tones within each subgroup can vary. The number can vary such that the subgroups can have from one to M tones where M is a given number. While not shown in the figures, subgroup 202 may have five tones and subgroup 204 may have four tones, etc.

During the operation of OFDM wireless communication systems, multiple devices 108, 110, such as wireless communication devices, are grouped into an OFDM message 200. There are a number of different ways that users are assigned into groups that make up the OFDM data streams. One such method is first-come-first-serve where the first wireless communication device using the OFDM system is assigned to the group that is accepting users such that the first user is assigned to message 200 and as the first user is assigned subgroup 202 within message 200. The second user is assigned to message 200 and as the second user is assigned subgroup 204. In first-come-first serve, there are no differences between the subgroups 202-210. When one message or group 200 fills up, the next wireless communication device is assigned the next message or group (not shown). Accordingly, the user is put into a subgroup on the one-by-one order at which the user needs OFDM services.

Another method of assigning wireless communication devices to a message or group 200 and the subgroups 202-210 therein is based on the channel used by the wireless communication device 108, 110. In this grouping technique, wireless communication devices are grouped based on channel conditions. In particular, the groupings can be based on different signal to noise ratios (SNR) and other measured conditions. Thus, users with similar channel conditions are put into the same group. For example, a first wireless device has a measured SNR and is therefore assigned to message 200 and as the first user is assigned subgroup 202. A second wireless device may have a different measured SNR and is therefore assigned to a second message (not shown) and as the first user is assigned the first subgroup within that message. If a third wireless communication device requests service and has the same SNR as the first wireless communication device, the third device will be assigned to message 200 and as the second user within that group will be assigned to subgroup 204.

In yet another method of assigning wireless communication devices to messages or groups 200, the devices are assigned according to Quality of Service (QoS) criteria. QoS criteria include, but are not limited, to voice, instant messaging, narrow-band vocoder, wide-band vocoder, data, and video. Thus, users with similar QoSs are put into the same group. For example, a first wireless device has a first QoS and is therefore assigned to message 200 and as the first user is assigned subgroup 202. A second wireless device may have a different QoS and is therefore assigned to a second message (not shown) and as the first user is assigned the first subgroup within that message. If a third wireless communication device requests service and has the same QoS as the first wireless communication device, the third device will be assigned to message 200 and as the second user within that group will be assigned to subgroup 204.

As described above, each subgroup 202-210 is assigned a given number of tones 212-224. Each subgroup is given enough capacity to carry a single packet and in the case of voice communication a single voice packet. Thus, each subgroup is assigned tones to carry a single voice packet. As will be appreciated by those of skill in the art, the number of tones in each subgroup may be the same or may be different depending on how the network 100 operates. It is highly desirable to have the propagation channels of tones within each subgroup to be as un-correlated as possible. It is understood that the propagation channels of adjacent tones are highly correlated and that the propagation channels of tones that are separated from one another are considered to be uncorrelated. Depending on the method of grouping, as described above, the number of tones in each subgroup may vary such that subgroup 202 has a first number of tones and subgroup 204 has a second number of tones different or the same as the first number. With the number of tones assigned to each subgroup, each subgroup is given an index. It is the assigned index of each subgroup that needs to be identified to the wireless communication device 108, 110 so that the device can receive the data designated for it.

The notification comprises of information that informs the device of the subgroup in which the data packet designated for it is. Accordingly, the network 100, including the BSC 102 and BTSs 104, 106, provides the wireless communication device 108, 110 three elements to identify the proper subgroup. As seen in FIG. 3, these elements may be arranged in a message 300 and include the ID sequence 302 for the device, a subgroup index 304 and a new data indicator 306. As can be appreciated by those of skill in the art, the ID sequence 302 is a unique ID for each device. The subgroup index 304 is the index or identification given each subgroup 202-210 within a message or group 200, as discussed above. The new data indicator 306 is the part of the message which indicates to the device whether the message 200 includes new data for the device.

The message 300 can be of differing lengths. In order to reduce overhead and achieve the scheduling gains, the length of message 300 is kept small. Thus, the ID 302 sequence may be reduced in size by using only as many bits as is necessary for the number of users using the message 200. Thus, if sixteen are using the message the ID sequence 302 can be as small as four bits. Likewise, it is desired to reduce the size of the subgroup index 304 to the number of bits necessary to describe the index. As the new data indicator 306 designates whether new data is present or not, the new data indicator 306 can be as small as one bit, where a zero indicates no new data and a one indicates new data.

FIG. 4 illustrates message 400 which is an alternative to message 300. As seen, message 400 includes ID sequence 402, which corresponds to ID sequence 302, and new data indicator 406, which corresponds to new data indicator 306. Messages 400 are arranged in an order to indicate the subgroup index. In other words, messages 400 is arranged for multiple wireless communication devices such that a first portion message 400, which includes the ID sequence and the new data indicator for the first wireless device in the group 200, is in the first position within message 400, the second portion of message 400, which includes the ID sequence and new data indicator for the second wireless device in the group 200, is in the second position, the third portion of message 400, which includes the ID sequence and new data indicator for the third wireless device in group 200, is in the third position, and so on. In other works, message 400 is in the pattern of ID sequence 1, new data indicator 1, ID sequence 2, new data indicator 2, ID sequence 3, new data indicator 3, and so on. Thus, it is implicit that ID sequence 1 uses subgroup 1, ID sequence 2 uses subgroup 2, ID sequence 3 uses subgroup 3 and so on.

In yet another embodiment, the number of subgroups in message 200 is equal to 1. In this scenario it is not necessary to send the subgroup index to the device. Thus, the message 400 can be sent as message 300. In the construction for message 400, the one subgroup is put in the first position.

The (notification) messages 300, or 400 themselves are transmitted on pre-designated group of tones. A group of frequency diverse tones can be dedicated for the purpose of notification. This makes up a control channel that the devices monitor either continuously or intermittently according to a predetermined discontinuous reception (DRX) regimen. Of course, the notification messages may employ a fixed modulation scheme (e.g. QPSK) with a predetermined channel coding mechanism. Since these messages are short, the preferred channel coding schemes could be algebraic block codes such as Reed-Muller, Reed-Solomon, BCH, etc. Convolutional codes can also be used with modifications such as the well known “tail-biting” codes.

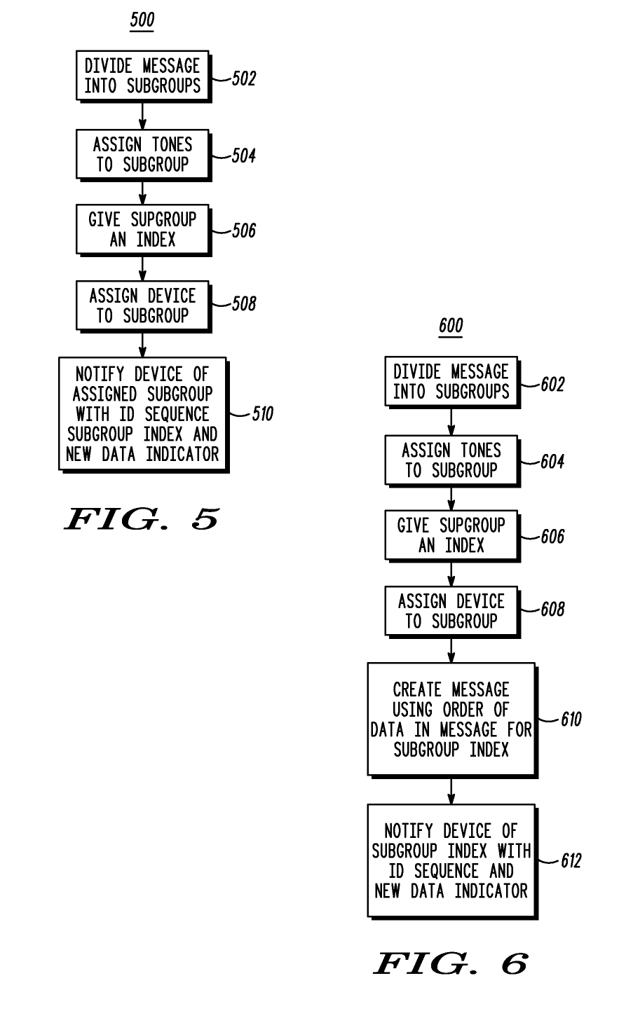

Turning to FIG. 5, the method 500 of informing a device 108, 110 of the subgroup index 304 is described in accordance with one embodiment of the present invention. To begin, a message 200 is divided 502 into a number of subgroups 202-210. Each subgroup 202-210 is assigned 504 a number of tones 212-224 whereby each subgroup 202-210 has enough capacity in the number of tones 212-224 to carry at least a signal packet to a device. Once the number of tones has been assigned, each subgroup is given 506 an index to identify to a device the subgroup 202-210 that contains the packet of data for that device. When data is sent to the device 108, 110, the data and the user are assigned 508 a group 200 and subgroup 202-210. This assignment can be done on a first-come-first-serve basis, according to channel parameters or according to Quality of Service parameters. The device is notified 510 of the assigned subgroup 202-210 by forwarding message 300 to the device. Message 300 includes the ID sequence 302, the subgroup index 304 and the new data indicator 306.

In FIG. 6, a method 600 of informing a device of the subgroup index is described in accordance with another embodiment of the present invention. To begin, a message 200 is divided 602 into a number of subgroups 202-210. Each subgroup 202-210 is assigned 604 a number of tones 212-224 whereby each subgroup 202-210 has enough capacity in the number of tones 212-224 to carry at least a signal packet to a device. Once the number of tones has been assigned, each subgroup is given 606 an index to indicate to a device the subgroup 202-210 that contains the packet of data for that device. When data is sent to the device, the data and the user are assigned 608 a group 200 and subgroup 202-210. This assignment can be done on a first-come-first-serve basis, according to channel parameters or according to Quality of Service parameters. Message 400 is created 610 by arranging it in a designated order according to the number of the subgroup each device is assigned. In other words, message 400 is formed by putting the device in the first subgroup 202 in the first position of the message, the device in the second subgroup 204 in the second position in the message and the device in the third subgroup 206 in the third position of the message. Each ID sequence 402 has a new data indicator 406 associated with it. The device is notified 612 of the assigned subgroup 202-210 by forwarding message 400 to the device. Message 400 includes the ID sequence 402, the new data indicator 406.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of notifying a communication device of an allocation of data within a multiplexed message, the method comprising:
grouping the data of an at least one communication device into the multiplexed message;
dividing the multiplexed message into at least one subgroup wherein each subgroup has at least one tone and is within the message;
assigning the communication device one of the at least one subgroup, and
notifying the communication device of the assigned subgroup with an identification sequence used to identify the communication device, a first index to identify when the assigned subgroup includes new data for the communication device and a second index to identify which subgroup within the multiplexed message contains data for the communication device.

2. The method according to claim 1 wherein the step of grouping is formed by one of the steps from among the group comprising filling up the message on a first come first serve basis of communication devices, assigning the wireless communication device to a group according to the channel condition of the wireless communication device and assigning the communication device to a group according to the quality of service requested by the communication device.

3. The method according to claim 1 wherein the identification sequences used to identify the communication devices within a sub-group, which has a length that depends upon the number of users within the subgroup.

4. The method according to claim 1 wherein subgroups include a number of tones for each communication device assigned to the subgroup.

5. The method according to claim 1 wherein the number of subgroups serves as the second index.

6. The method according to claim 5 wherein the number of subgroups is one.

7. The method according to claim 1 wherein the order of the data within the message serves as the second index.

8. A method of notifying a communication device of an allocation of data within a multiplexed message, the method comprising:
grouping the data of an at least one communication device into the multiplexed message;
dividing the multiplexed message into at least one subgroup wherein each subgroup has at least one tone and is within the message;
assigning the wireless device one of the at least one subgroup, and
notifying the communication device of the assigned subgroup with an identification sequence used to identify the communication device and an index to identify when the assigned subgroup includes new data for the communication device and wherein the identification sequence and the index are sequenced in order within the message according to the number of the assigned subgroup.

9. The method according to claim 8 wherein the step of grouping is formed by one of the steps from among the group comprising filling up the message on a first come first serve basis of communication devices, assigning the communication device to a group according to the channel condition of the communication device and assigning the communication device to a group according to the quality of service requested by the communication device.

10. The method according to claim 8 wherein the identification sequences used to identify the communication devices within a sub-group, which has a length that depends upon the number of users within the subgroup.

11. The method according to claim 8 wherein subgroups include a number of tones for each communication device assigned to the subgroup.

12. The method according to claim 8 wherein the number of subgroups serves as the second index.

13. The method according to claim 12 wherein the number of subgroups is one.

14. A message to notify a communication device within an orthogonal frequency division multiplexed network of a subgroup within a multiplexed message having data for the communication device, the message comprising:
an identification sequence used to identify the communication device;
a first index used to identify whether the multiplexed message contains data for the communication device, and
an indication of the subgroup within the multiplexed message.

15. The message according to claim 14 wherein the indication comprises a second index to identify the subgroup within the multiplexed message.

16. The message according to claim 14 wherein the indication comprises the order of the identification sequences and the first index within the message corresponds to the subgroup within the multiplexed message.

17. The message according to claim 14 wherein the identification sequences has a length that depends upon the number of users within the subgroup and wherein the subgroups include a number of tones for each communication device assigned to the subgroup.

18. A communication device comprising:
a transceiver; and
a controller coupled with the transceiver the controller being programmed to operate the transceiver,
wherein the transceiver receives a message notifying the communication device of a subgroup within a multiplexed message wherein the subgroup contains data for the communication device and wherein the message includes an identification sequence used to identify the communication device, a first index to identify when the assigned subgroup includes new data for the communication device and a second index to identify which subgroup within the multiplexed message contains data for the communication device.

19. The communication device according to claim 18 wherein the identification sequences used to identify the communication devices within a sub-group, which has a length that depends upon the number of users within the subgroup.

20. The communication device according to claim 18 wherein subgroups include a number of tones for each communication device assigned to the subgroup.
